(19) United States
(12) Patent Application Publication
(10) Pub. No.: US 2018/0278905 A1
(43) Pub. Date: Sep. 27, 2018

(54) PROJECTION APPARATUS THAT REDUCES MISALIGNMENT BETWEEN PRINTED IMAGE AND PROJECTED IMAGE PROJECTED ON THE PRINTED IMAGE, CONTROL METHOD THEREFOR, AND STORAGE MEDIUM

(71) Applicant: CANON KABUSHIKI KAISHA, Tokyo (JP)

(72) Inventor: Kazuhiko Nakazawa, Kawasaki-shi (JP)

(21) Appl. No.: 15/926,889

(22) Filed: Mar. 20, 2018

(30) Foreign Application Priority Data
Mar. 23, 2017 (JP) 2017-057456

(51) Int. Cl. H04N 9/31

(52) U.S. Cl. CPC H04N 9/3194; G06F 3/042; H04N 9/3126

(57) ABSTRACT

A projection apparatus which is capable of, in a case where misalignment occurs between a printed image and a projected image when the projected image is projected on printed material based on image data, making the misalignment less conspicuous. Misalignment between the projected image projected on the printed material and the printed image formed on the printed material is detected. An image is projected on the printed material based on a converted image data obtained by converting a spatial frequency of at least one region of the image data into low frequency, the at least one region of the image data including the detected misalignment.

### BACKGROUND OF THE INVENTION

### Field of the Invention

The present invention relates to a projection apparatus, a control method therefor, and a storage medium.

### Description of the Related Art

High dynamic range images (hereafter abbreviated as “HDR images”) with high dynamic range has high expressive power in terms of color, gradations, textures, and so forth, and hence they are used in various scenes in increasing opportunities. Accordingly, various techniques to regenerate images taken by digital cameras and the like as HDR images have been proposed.

Direct-view-type display devices such as liquid crystal displays and organic electroluminescent displays are widely used to reproduce images, but in general, these display devices are capable of reproducing images with luminance levels ranging from about 1 to 1000 cd/m². Therefore, for example, when these display devices are to reproduce an HDR image with a luminance level of 1000 cd/m² or higher, the HDR image needs to be subjected to a gradient compression process called tone mapping. In this case, a dynamic range which the HDR image originally has cannot be satisfactorily expressed.

On the other hand, an image projection apparatus (projector) is capable of reproducing images with high white luminance levels. However, the image projection apparatus has a problem that a minute quantity of light is projected even in black-color display, and therefore, contrast lowers. In particular, as luminance of projection increases, black luminance rises, causing black level maladjustment. Printed material printed by a printer or the like does not have maladjusted black level as distinct from the image projection apparatus, but cannot achieve higher brightness than illumination light and thus cannot achieve a satisfactorily high dynamic range.

Therefore, there has been proposed a technique to improve contrast by projecting an image on printed material such as a sheet, on which an image is printed, by the image projection apparatus and superimposing the projected image on the printed image so as to extend a luminance dynamic range and a color range (see, for example, Japanese Laid-Open Patent. Publication (Kokai) No. 2007-334179

According to the above prior art, the image projection apparatus is used to project the projected image after changing its shape so that the projected image can perfectly overlay the printed image. However, the amount by which the shape of the projected image is changed is limited due to hardware or the like of the image projection apparatus. As a result, there may be an area where there is misalignment between the printed image and the projected image. In addition, when the printed material has a distortion or the like, there is likely to be an area where there is misalignment between the printed image and the projected image. A user tends to feel such misalignment between the printed image and the projected image as a hindrance to visibility. Particularly, when an image is projected on printed material which is a sheet, the sheet is likely to become distorted due to pressure, humidity, or the like, and hence misalignment is likely to occur between the printed image and the projected image.

### SUMMARY OF THE INVENTION

The present invention provides a projection apparatus which is capable of, in a case where misalignment occurs between a printed image and a projected image when the projected image is projected on printed material, making the misalignment less conspicuous, a control method therefor, and a storage medium.

Accordingly, the present invention provides a projection apparatus which projects an image on printed material, the projection apparatus comprising a projection unit configured to project an image on the printed material based on image data, a detecting unit configured to detect misalignment between a projected image projected on the printed material by the projection unit and a printed image formed on the printed material, and a control unit configured to control the projection unit to project an image on the printed material based on a converted image data obtained by converting a spatial frequency of at least one region of the image data into low frequency, the at least one region of the image data including the misalignment detected by the detecting unit.

According to the present invention, in the case where misalignment occurs between the printed image and the projected image when the projected image is projected on the printed material, the misalignment is made less conspicuous.

Further features of the present invention will become apparent from the following description of exemplary embodiments (with reference to the attached drawings).

### BRIEF DESCRIPTION OF THE DRAWINGS

FIG. 1A is a block diagram schematically showing an arrangement of an image projection apparatus according to embodiments of the present invention, and FIG. 1B is a view useful in explaining a relationship between a printed image and a projected image.

FIGS. 2A to 2E are views useful in explaining a relationship between a printed image and a projected image.

FIG. 3 is a flowchart showing the procedure of an image projecting process according to the first embodiment of the present invention.

FIGS. 4A to 4C are views useful in explaining processes in steps S303 and S304.

FIGS. 5A and 5B are views in schematic form showing superimposed images in steps S305 and S310.

FIG. 6 is a flowchart showing the procedure of an image projecting process according to the second embodiment of the present invention.

### DESCRIPTION OF THE EMBODIMENTS

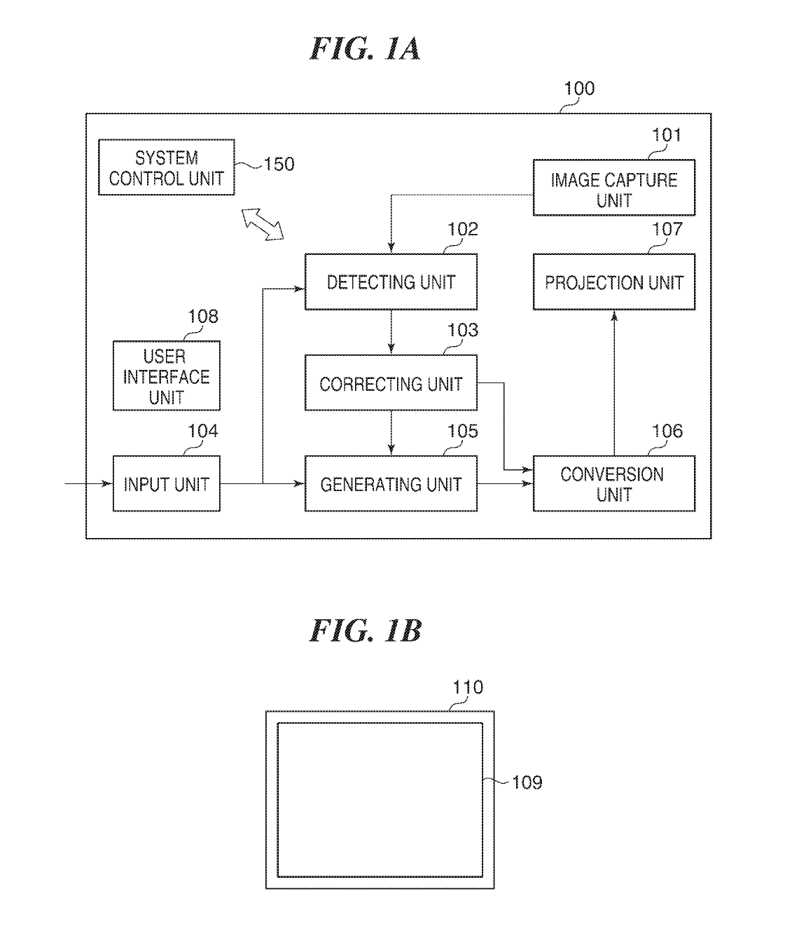

Embodiments of the present invention will now be described in detail with reference to the accompanying drawings. FIG. 1A is a block diagram schematically showing an arrangement of an image projection apparatus 100 according to the embodiments of the present invention, and FIG. 1B is a view useful in explaining a relationship between a printed image 110, which is subjected to image projection by the image projection apparatus 100, and a projected image 109 which is superimposed on the printed image 110.

The image projection apparatus 100 has a system control unit 150 that has a CPU (arithmetic processing circuit), a ROM, a RAM, an A/D converter, a D/A converter, and so forth. In the system control unit 150, the CPU expands computer programs stored in the ROM into the RAM to control operation of components constituting the image projection apparatus 100, enabling overall control of the image projection apparatus 100.

The image projection apparatus 100 also has an image capture unit 101, a detecting unit 102, a correcting unit 103, an input unit 104, a generating unit 105, a conversion unit 106, a projection unit 107, and a User Interface unit 108. These components are integrally controlled by the system control unit 150.

The image capture unit 101 has a lens, a solid-state image pickup device such as a CCD sensor or a CMOS sensor, which converts an image of light incident through the lens into an electric signal, an image processing circuit that generates image data from an output signal from the solid-state image pickup device, and so forth. The image capture unit 101 is used to shoot the printed image 110. It should be noted that in the present embodiment, the printed image 110 means an image printed on a predetermined medium such as a sheet, that is, an image formed on a front side of printed material. In the following description, the wording “project an image on the printed image 110” will be used as appropriate, and this means that an image is superimposed by projection on the front side of the printed material on which the printed image 110 is formed.

The input unit 104, which is comprised of a terminal conforming to communication standards such as HDMI (registered trademark), a processing circuit therefor, and so forth, obtains image data and video data (hereafter referred to as “the input image”) externally from the image projection apparatus 100 and sends the obtained input image to the detecting unit 102 and the corrected image generating unit 105. The detecting unit 102 detects an amount of misalignment between the projected image 109 and the printed image 110 from the input image obtained from the input unit 104 and the shot image obtained from the image capture unit 101. It should be noted that although in the example shown in FIG. 1B, the projected image 109 is smaller than the printed image 110, the printed image 110 and the projected image 109 may be of the same size, or the printed image 110 may be larger than the projected image 109.

Based on the amount of misalignment detected by the detecting unit 102, the correcting unit 103 generates a misalignment correction value for the projected image 109 and outputs the generated misalignment correction value to the corrected image generating unit 105. It should be noted that the correcting unit 103 grasps of a limit to a correction capability of the corrected image generating unit 105, and when misalignment remains uncorrected for after the misalignment correction, misalignment information after the misalignment correction is sent to the conversion unit 106.

The corrected image generating unit 105 generates a misalignment corrected image by correcting for the image misalignment based on the input image obtained from the input unit 104 and the misalignment correction value obtained from the correcting unit 103 and sends the misalignment corrected image to the conversion unit 106. Examples of processes carried out by the corrected image generating unit 105 include a keystoning (trapezoid correction) process and a warping process. It should be noted that in the warping process, a characteristic point on an image is designated, and a moving distance of the designated characteristic point is determined to generate a new image. However, the misalignment correction method executed by the corrected image generating unit 105 is not limited to them.

Based on the misalignment information after the misalignment correction obtained from the correcting unit 103, the conversion unit 106 carries out a frequency conversion process on the misalignment corrected image obtained from the corrected image generating unit 105. Here, a frequency in the frequency converting process means a spatial frequency of the image. It should be noted that when the misalignment information after the misalignment correction has not been obtained, the frequency conversion process is not carried out. The conversion unit 106 sends the image subjected to the frequency conversion process or the image that has not been subjected to the frequency conversion process to the projection unit 107.

It should be noted that the system control unit 150, the detecting unit 102, the correcting unit 103, the corrected image generating unit 105, and the conversion unit 106 may be each comprised of an arithmetic device such as a microcomputer or an ASIC. However, this is not limitative, but these components may be implemented either by software (programs) or by hardware or may be implemented by both software and hardware. Functions of these components and processes carried out by them will be described later with a description of control over image projection by the image projection apparatus 100.

The projection unit. 107 has a light source such as a halogen lamp or a laser, an optical device such as a prism or a mirror, a display panel such as a liquid crystal panel or an LCOS panel, and a projection lens. In the present embodiment, the projection unit 107 superimposes the projected image 109 on the printed image 110 by image projection. The projection unit 107 projects the projected image 109 on the front side of printed material on which the printed image 110 is formed. In the following description, it is assumed that, for the sake of convenience, the medium on which the printed image 110 is formed is a sheet. A user views an image for viewing (hereafter referred to as “the superimposed image”) formed by superimposing the projected image 109 on the printed image 110. The User Interface unit 108 has an input means (operating unit), which is comprised of buttons, a mouse, a remote controller, or the like, a display, and so forth, and receives operations input by the user and provides the user with information. The system control unit 150 stores various values which are set via the User Interface unit 108 by the user so as to adjust processes, operations, and so forth in the image projection apparatus 100.

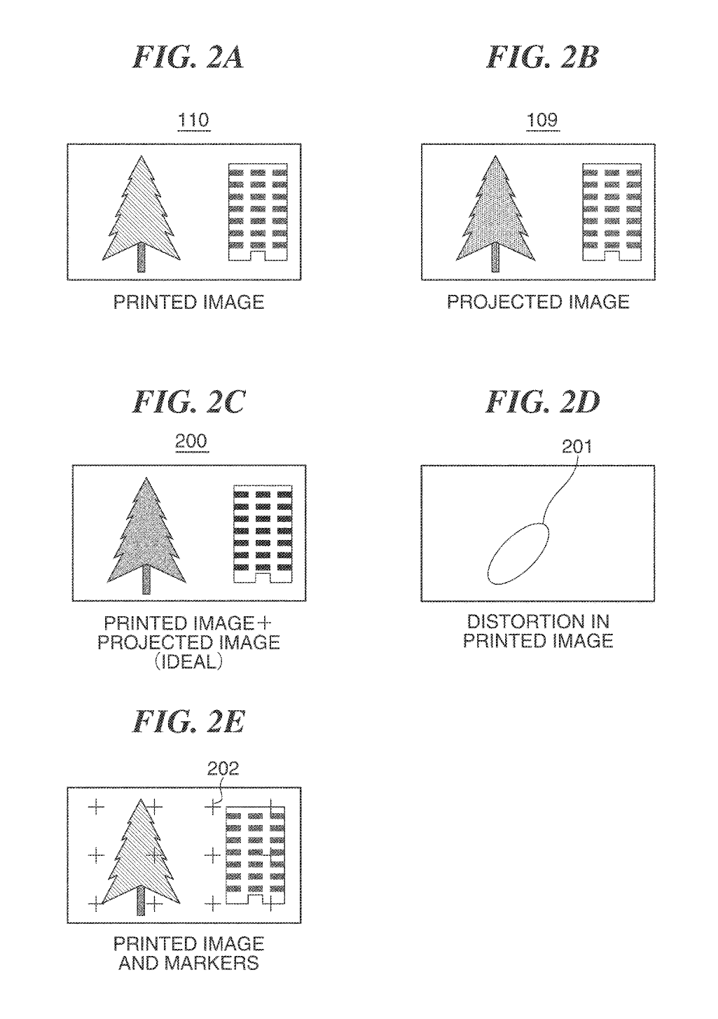

Next, a concrete description will be given of a relationship between the printed image 110 and the projected image 109. FIG. 2A is a view showing an example of the printed image 110. FIG. 2B is a view showing an example of the projected image 109 and shows in schematic form a state in which the projected image 109 is projected on a plain white screen. FIG. 2C is a view showing a superimposed image 200 formed by ideally superimposing the projected image 109 on the printed image 110. In this example, for the convenience of explanation, the rendered object in the projected image 109 and their relative positional relationship are the same as the rendered object in the printed image 110 and their relative positional relationship. However, gradation values (luminance levels) of pixels at the same position in the printed image 110 and the projected image 109 do not have to be equal.

The projected image 109 is projected on the printed image 110 so that the subject in the projected image 109 can overlay the subject in the printed image 110. The user views the superimposed image formed by thus superimposing the projected image 109 on the printed image 110. At this time, as can be seen from the superimposed image 200 in FIG. 2C, it is ideal that the projected image 109 overlays the printed image 110 without being misaligned, and this forms the superimposed image with high contrast. As a result, the user views the image that is realistic.

FIG. 2D is a view showing in schematic form a state in which the sheet as the medium on which the printed image 110 is printed has a distorted area 201. The distorted area 201 may be formed due to the influence of pressure, humidity, or the like. FIG. 2E is a view useful in explaining markers 202 for alignment which are printed on the sheet on which the printed image 110 is printed. It should be noted that the markers 202 can be regarded as part of the printed image 110. In this example, 12 cross-shaped markers 202 consisting of 3 markers in a vertical direction and 4 markers in a horizontal direction are printed, but the shape, number, and arrangement of the markers 202 are not limited to this. It should be noted that the markers 202 would hinder viewing if the user visually recognizes them, and hence in the present embodiment, it is assumed that the markers 202 are printed in ink or the like which has a property of not reflecting visible light. Positional information on the markers 202 as well as the input image is input to the input unit 104, which in turn sends them to the detecting unit 102.

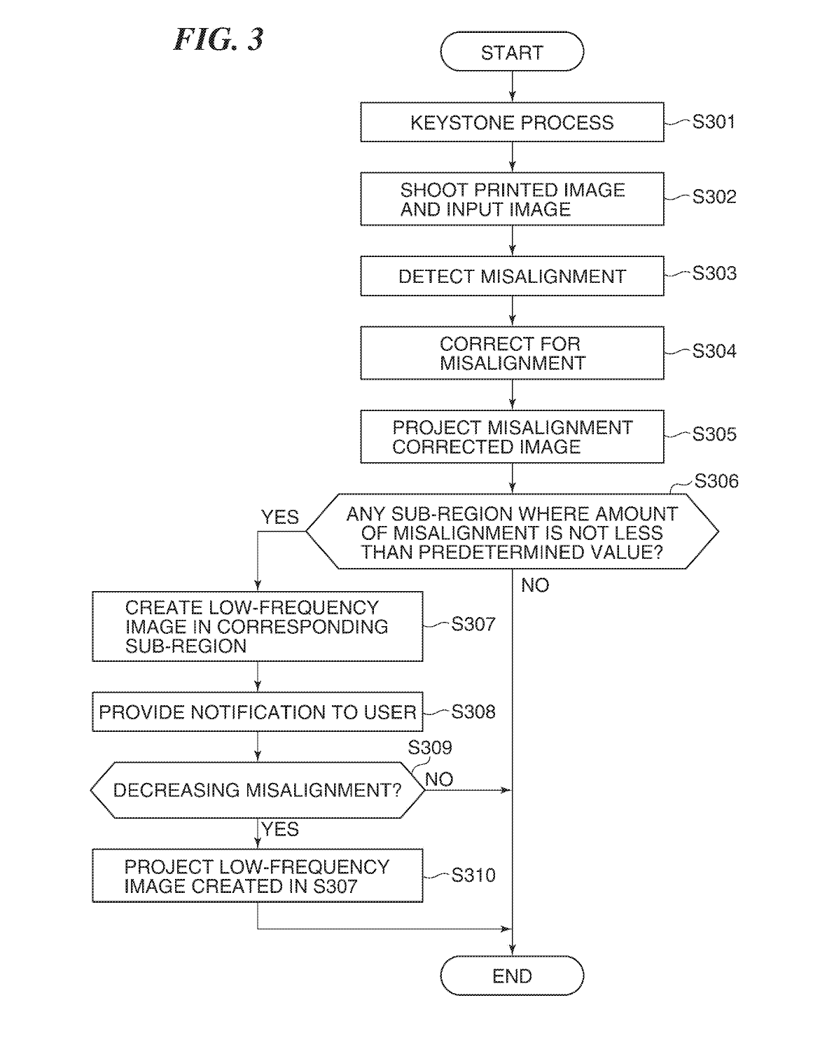

FIG. 3 is a flowchart showing the procedure of an image projecting process according to the first embodiment of the present invention. Processes in the flowchart of FIG. 3 are carried out by the system control unit 150 of the image projection apparatus 100 executing predetermined programs to integrally control operation of the components constituting the image projection apparatus 100 and causing the components to perform designated operations and processes.

The present process is started based on the assumption that the printed material on which the printed image 110 is formed has been placed at a predetermined position In step S301, the system control unit 150 irradiates the printed image 110 with light from the projection unit 107 and carries out the keystoning process in accordance with an instruction from the user via the User Interface unit 108. In the keystoning process, for example, the projection unit 107 projects a monochrome rectangular image on the printed image 110. Then, while seeing a projected area in the printed image 110, the user operates the User Interface unit 108 to adjust the projection unit 107 so that corners of the projected area can match corners of an image area of the printed image 110. Upon receiving an instruction to end the keystoning process via the User Interface unit 108, the system control unit 150 ends the present process and stores an adjustment value for the projection unit 107. Thereafter, the stored correction value is used for image projection by the projection unit 107.

In step S302, the system control unit 150 controls the image capture unit 110 to shoot the printed image 110 and controls the input unit 104 to obtain the input image and the positional information on the markers 202. It is assumed here that the printed image 110 is an image shown in FIG. 2E, and the input image is image data for projecting the projected image 109 shown in FIG. 2B. It should be noted that when the image capture unit 110 shoots the printed image 110, no light is thrown from the projection unit 107 to the printed image 110. Also, it should be noted that the image capture unit 110 is capable of shooting the markers 202 (light of wavelengths outside the visible region). The shot image obtained by the image capture unit 110 has a trapezoidal shape, depending on an angle of shooting, and hence the system control unit 150 carries out the keystone process on the shot image as necessary.

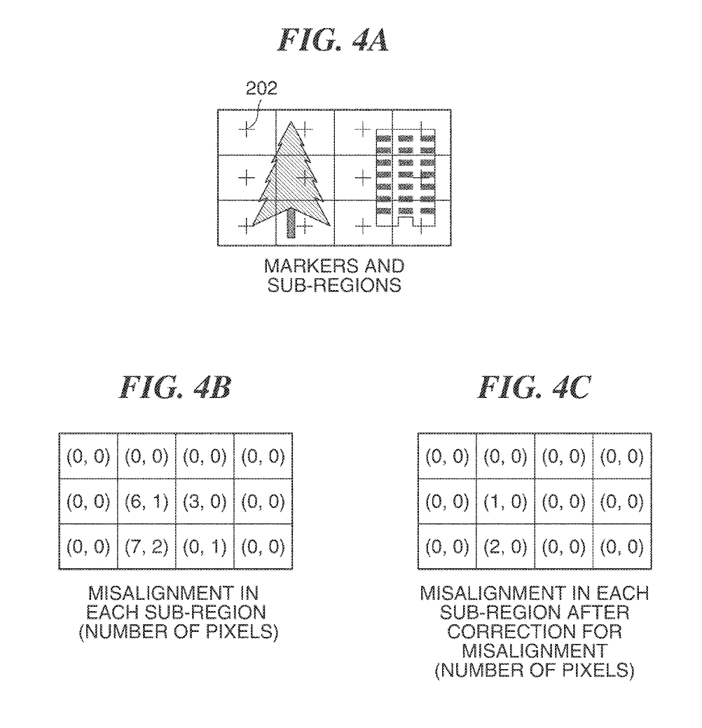

In step S303, based on positions of the markers 202 in the shot image obtained in the step S302 and the positional information on the markers 202 obtained from the input unit 104, the detecting unit 102 calculates amounts of misalignment in sub-regions obtained by dividing the printed image 110 and the projected image 109 into a plurality of regions. FIGS. 4A to 4C are views useful in explaining the processes in the steps S303 and S304. Positions at which the markers 202 lie when the input image subjected to the keystone correction is projected on the printed image 110 by the projection unit 107 are calculated based on the positional information on the markers 202 obtained from the input unit 104. The calculated positions are compared with the positions of the markers 202 the shot image which are extracted from the shot image.

Specifically, as shown in FIG. 4A, the plurality of sub-regions with the markers 202 at the centers thereof are set in each of the input image and the shot image. In the present embodiment, a total of 12 sub-regions consisting of 3 equal regions in a vertical direction and 4 equal regions in a horizontal direction are set. For example, when an upper left marker and a lower right marker in the shot image are aligned with an upper left marker and a lower right marker, respectively, of the input image, amounts of misalignments between the other markers are each calculated as the number of pixels which represents an amount of misalignment in each of the sub-regions. As a result, it is assumed that amounts of misalignment represented by (6, 1), (3, 0), and so forth in FIG. 4B have been detected. It should be noted that numerical values on the left side in (6, 1), (3, 0), and so forth represent amounts of misalignment in the horizontal direction, numerical values on the right side in (6, 1), (3, 0), and so forth represent amounts of misalignment in the vertical direction, and (0, 0) indicates that there is no misalignment. Since the printed image 110 has the distorted region 201 shown in FIG. 2D, it can be seen that there is misalignment in the regions corresponding to the distorted region 201 (the sub-regions with the misalignment (6, 1), (7, 2), (3, 0), and (0, 1)).

In the step S304, the correcting unit 103 obtains a misalignment correction value for correcting the input image based on the amounts of misalignment calculated by the detecting unit 102, and then the corrected image generating unit 105 generates a misalignment corrected image by correcting for the misalignment based on the input image and the misalignment correction value. It is assumed here that because of hardware or software constraints, the misalignment can be corrected for five or less pixels in each of the horizontal direction and the vertical direction in each of the sub-regions. As a result of the process in the step S304, the amounts of misalignment in FIG. 4B are reduced in the respective sub-regions as shown in FIG. 4C.

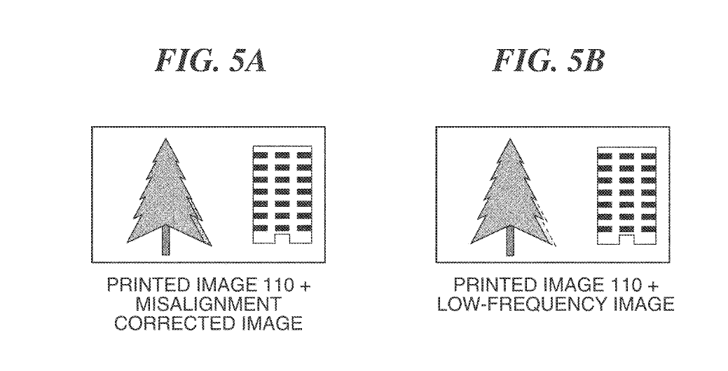

In step S305, the frequency conversion unit 105 sends the misalignment corrected image to the projection unit 107 without performing any processing on the misalignment corrected image, and the projection unit 107 in turn projects the misalignment corrected image on the printed image 110. FIG. 5A is a view in schematic form, showing the superimposed, image formed by projecting the misalignment corrected image on the printed image 110. As shown in FIG. 4C, the misalignment corrected image has two sub-regions where misalignments remain without being corrected for, and therefore, in the corresponding sub-regions, there is misalignment between the projected misalignment corrected image and the printed image 110. It should be noted that FIG. 5A shows the misalignment between the misalignment corrected image and the printed image 110 in an exaggerated manner.

In step S306, the system control unit 150 judges whether or not there is any sub-region where an amount of misalignment is equal to or greater than a predetermined value. In the present embodiment, it is assumed that the predetermined value is two, but the predetermined value is not limited to this, but for example, the predetermined value may be set by the user operating the User Interface unit 108. Therefore, when there is any sub-region where there is misalignment of two pixels in at least one of the horizontal direction and the vertical direction, the judgment result in the step S306 is positive (YES). On the other hand, when the amount of misalignment in each of the horizontal direction and the vertical direction is equal to or smaller than one pixel, the judgment result the step S306 is negative (NO). When the system control unit 150 judges that there is any sub-region where the amount of misalignment is equal to or greater than the predetermined value (YES in the step S306), the process proceeds to step S307. On the other hand, when the system control unit 150 judges that there is no sub-region where the amount of misalignment is equal to or than the predetermined value (NO in the step S306), the present process is ended, and as a result, the state of projection in the step S305 continues.

When at least one sub-region with the misalignment of (2, 0) shown in FIG. 4B still remains, the process proceeds to step S307. In the step S307, the conversion unit 106 creates a low-frequency image by converting a frequency of the sub-region where the amount of misalignment is equal to or greater than the predetermined value into low frequency. As the degree of conversion into low frequency increases, an image to be crated becomes more blurry, and therefore, in the step S307, it is preferred that as the amount of misalignment increases, the degree of conversion into low frequency is increased. Examples of ways to create a low-frequency image include adaption of a low-pass filter to the Fourier transform. In this case, an image in a sub-region is subjected to the Fourier transform so as to be decomposed into frequency components. As the amount of misalignment increases, the band of high frequencies to be attenuated is widened, and the degree of attenuation is increased, or as the amount of misalignment increases, the band of low frequencies to be amplified is widened, and the degree of amplification is increased. Then, the frequency components are put back to the image by the inverse Fourier transform.

It should be noted that in the process in the step S307, making an area with misalignment still remaining less conspicuous suffices. Therefore, the way to implement the process in the step S307 is not limited to the way in which low-frequency components of a predetermined sub-region in the misalignment corrected image to be projected is amplified or high-frequency components of the predetermined sub-region is reduced. For example, when the image projection apparatus has capability to perform image processing on image data of the input image so as to change a luminance value (gradation value) and color of an area where misalignment still remains, the area where the misalignment still remains may be rendered in luminance or gradations of color. For example, when a dark-color tree lies off a light-color background as shown in FIG. 5A, transmittance of light through the liquid crystal panel of the projection unit 107 may be controlled on a pixel-by-pixel basis to render the area in gradations so that the luminance or color gradually varies from the background to the tree in the printed image 110. The process in the step S307 may also be implemented by mechanically adjusting the projection unit 107. For example, the focus of the lens of the projection unit 107 is shifted so as to blur an outline of the misalignment corrected image to be projected.

In S308, the system control unit 150 notifies the user that there is the region where the amount of misalignment is equal to or greater than the predetermined value via the User Interface unit 108. In this notification, a message saying, for example, “there is a region where misalignment with printed material cannot be corrected for perfectly. Would you like to carry out a process to decrease the misalignment?” is displayed on the display included in the User Interface unit 108. To receive a response to the message, the User Interface unit 108 has selection means such as buttons with which “YES” or “NO” is selected. The User Interface unit 108 inputs an instruction which indicates “YES” or “NO” is selected by user.

In step S309, the system control unit 150 judges whether or not the user has decided to carry out the process to decrease the misalignment via the User Interface unit 108. Upon judging that the user has decided not to carry out the process to decrease the misalignment (NO in the step S309), the system control unit 150 stores the user's instruction and then ends the present process. As a result, the state of projection started in the step S305 continues. When the system control unit 150 judges that the user has decided to carry out the process to decrease the misalignment (YES in the step S309), the process proceeds to step S310. In the step S310, the projection unit 107 projects the low-frequency image created in the step S307 on the printed image 110. FIG. 5B is a view in schematic form showing the superimposed image obtained by projecting the low-frequency image on the printed image 110. This enables the user to view the image with the misalignment reduced as shown in FIG. 5B, and the present process is ended.

It should be noted that the processing order in the flowchart in FIG. 3 may be changed as explained hereafter. Specifically, after the judgment result in the step S306 is positive (YES), the process may proceed to the step S308. Next, when the judgment result in the step S309 is positive (YES), the process in the step S307 may be carried out, and then the process may proceed to the step S310. In this case, when the judgment result in the step S309 is negative (NO), the process in the step S307 does not have to be carried out, and hence computation loads on the image projection apparatus 100 is lightened.

Although in the first embodiment described above, the superimposed image is formed by projecting the image on the front side of the printed material, the superimposed image may be formed by projecting the image on a back side of the printed material. In this case, the user sees a front side of the printed image 110 (the side of the printed material on which the printed image 110 is formed) as well. When the image is to be projected on the back side of the printed material, it is necessary to carry out a process in which the image to be projected is horizontally inverted before the step S305 and the step S310.

Moreover, although in the first embodiment described above, misalignment of the projected image 109 is detected and corrected for by means of the markers 202 with respect to each of the sub-regions, this is riot limitative, but misalignment may be corrected for with consideration given to positions of markers in neighboring sub-regions (amounts of misalignment in neighboring sub-regions). For example, for a sub-region where an amount of misalignment is larger than a maximum number of pixels that can be corrected per sub-region, the misalignment may be corrected for by pixels smaller in number to the maximum number of pixels with consideration given to an amount of misalignment in a neighboring sub-region

In the first embodiment described above, a sub-region where misalignment still remains without being corrected for is converted into a low-frequency image, and in this case, frequencies of the respective sub-regions may be taken into consideration. For example, frequency components of the respective sub-regions are analyzed, and for a sub-region including a number of low frequency components, the degree of conversion into low frequency (the degree to which an image is blurred) may be small. Conversely, for a sub-region including a number of high frequency components, the degree of conversion into low frequency (the degree to which an image is blurred) may be large. The reason for this is that even if a region including a number of low-frequency components is misaligned with the printed image 110, the region is less conspicuous when the user views the printed image 110.

As described above, in the first embodiment described above, an amount of misalignment of the projected image 109 projected on the printed image 110 is obtained by comparing (the image data of) the shot image obtained by shooting the printed image 110 and (the image data of) the projected image 109 with each other. Then, the misalignment corrected image is generated by making the correction with the bounds of possibility so as to reduce the amount of misalignment of the projected image 109, but when misalignment still remains without being corrected for, a region where the misalignment still remains is corrected to a low-frequency image. This improves quality of the superimposed image, making the user less likely to feel a hindrance in viewing it.

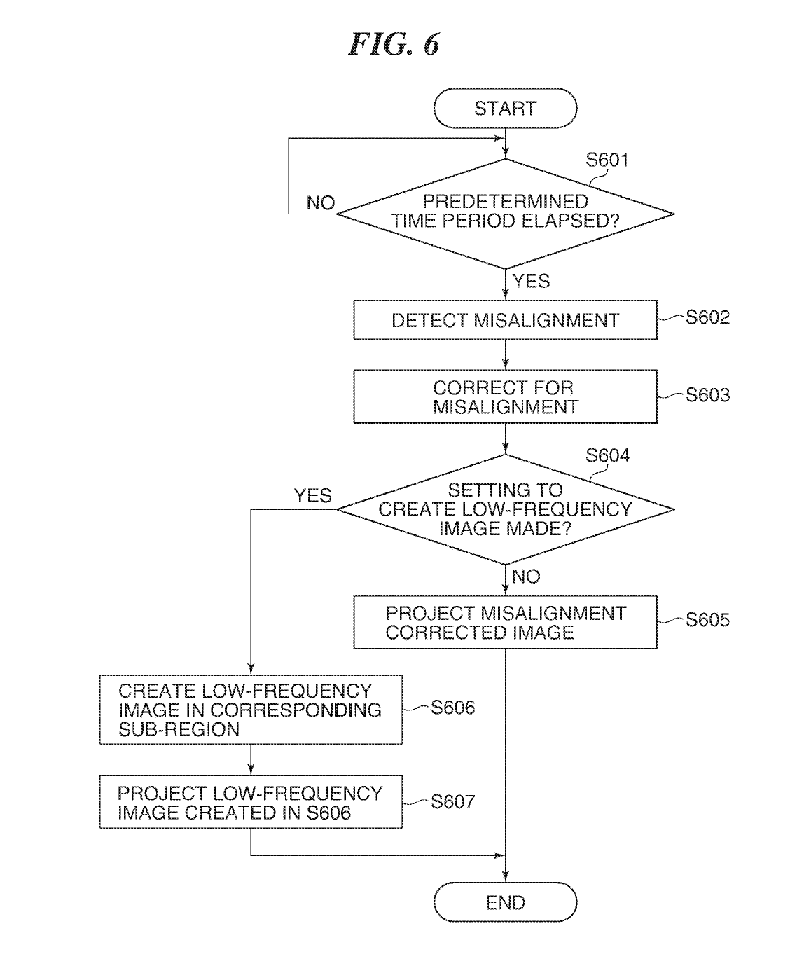

A description will now be given of a process according to a second embodiment of the present invention in which when misalignment between the printed image 110 and the projected image 109 occurs due to humidity, heat, or the like after image projection by the image projection apparatus 100, the misalignment is corrected for. FIG. 6 is a flowchart showing an image projecting process according to the second embodiment of the present invention, which is carried out by the image projection apparatus 100. Processes in the flowchart in FIG. 6 are implemented the system control unit 150 of the image projection apparatus 100 executing predetermined programs to integrally control operation of the component elements constituting the image projection apparatus 100 and causing the component elements to perform designated operations and processes.

It is assumed that before the process in step S601 is started, the process in the flowchart in FIG. 3 is carried out, and the misalignment corrected image (including low-frequency images) is projected on the printed image 110. In the step S601, the system control unit 150 judges whether or not a predetermined time period has elapsed since the projection of the projected image 109 was started. Either a fixed value determined in advance or a time period set by the user may be used as the predetermined time period. The system control unit 150 stands by until the predetermined time period has elapsed (NO in the step S601), and when the system control unit 150 judges that the predetermined time period has elapsed (YES in the step S601), the process proceeds to step S602. The processes in the steps S602 and S603 are the same as those in the steps S302 and S303, respectively, in the flowchart of FIG. 3, and hence detailed description thereof is omitted here. However, to carry out the process in the step S602, it is necessary to suspend the image projection on the printed image 110, shoot the printed image 110 by the image capture unit 101, and obtain positional information on the markers 202 in the printed image 110. It is preferred that the image projection onto the printed image 110 is resumed after the shooting of the printed image 110 by the image capture unit 101 is completed.

In step S604, the system control unit 150 judges whether or not a setting to create a low-frequency image has been made. Here, it is assumed that in the step S309 in the flowchart of FIG. 3, when the user decides to carry out the process to decrease the misalignment, that is, when the user decides to project the low-frequency image created in the step S307, the setting to create a low-frequency image has been made. However, in a case where the step S307 was not passed through in the process shown in the flowchart of FIG. 3 executed before the step S601, an initial setting on the image projection apparatus 100 is used. The initial setting may be either the setting to create a low-frequency image or a setting not to create a low-frequency image.

When the system control unit 150 judges that the setting to create a low-frequency image has not been made (NO in the step S604), the process proceeds to step S605, and when the system control unit 150 judges that the setting to create the low-frequency image has been made 0=in the step S604), the process proceeds to step S606. The process in the step S606 is the same as the step S305 in the flowchart of FIG. 3, and hence detailed description thereof is omitted here. The process in the step S606 and the process in step 607, which is carried out after the step S606, are the same as those in the steps S307 and S310, respectively, in the flowchart of FIG. 3, and hence description thereof is omitted here.

Although in the flowchart of FIG. 6, the process is ended after the step S605 or S607, the process may be return to the step S601 after the process in the step S605 or S607. Namely, it is preferred that as long as the image projection on the printed material is continuing, the processes in the steps S602 to S607 are repeatedly carried out each time the predetermined time period in the step S601 has elapsed. As a result, particularly in the case where the setting to create a low-frequency image has been made, the quality of the superimposed image is maintained.

In the second embodiment described above, an amount of misalignment of the projected image 109 with the printed image 110 is detected on a regular basis to correct for the misalignment, and if necessary, a low-frequency image is recreated and projected. As a result, the user is less likely to feel a hindrance in viewing the superimpose image, and the improved quality of the superimposed image is maintained.

It should be noted that although in the above description, the sheet on which the image is printed is used as the printed material that is subjected to image projection, the printed material is not limited to the sheet, but the printed material may be a metallic thin board or a resin thin board on which the image is printed. It is feared that even such printed material will contract, expand, or become distorted due to the influence of heat or the like, causing misalignment between the printed image and the projected image, and hence the present invention is applied to such printed material so as to maintain the quality of the superimposed image.

Moreover, although in the example described above, the rendered object in the projected image 109 and the relative positional relationship between them are the same as the rendered object in the printed image 110 and the relative positional relationship between them, but the rendered object in the projected image 109 and the rendered object in the printed image 110 may be different. In this case as well, amounts of misalignment between the printed image 110 and the projected image 109 should be obtained for the respective sub-regions based on positions of markers formed in the printed image 110 and positions of markers formed in the projected image 109.

### Other Embodiments

Embodiment (s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment (s) and/or that includes one or more circuits (e.g., application specific integrated circuit. (ASIC)) for performing the functions of one or more of the above-described embodiment (s), and by a method performed by the computer of the system or apparatus by, for example, reading out and executing the computer executable instructions from the storage medium to perform the functions of one or more of the above-described embodiment (s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-057456, filed Mar. 23, 2017 which is hereby incorporated by reference herein in its entirety.

What is claimed is:

1. A projection apparatus which projects an image on printed material, the projection apparatus comprising:
a projection unit configured to project an image on the printed material based on image data;
a detecting unit configured to detect misalignment between a projected image projected on the printed material by the projection unit and a printed image formed on the printed material; and
a control unit configured to control the projection unit to project an image on the printed material based on a converted image data obtained by converting a spatial frequency of at least one region of the image data into low frequency, the at least one region of the image data including the misalignment detected by the detecting unit.

2. The projection apparatus according to claim 1, wherein:
each of the printed image and the projected image has a plurality of sub-regions, and
the detecting unit detects, for each of the plurality of sub-regions, amounts of misalignment between the printed image and the projected image.

3. The projection apparatus according to claim 2, further comprising a correcting unit configured to convert a spatial frequency of at least one region including the misalignment detected by the detecting unit into low frequency,
wherein the correcting unit converts the spatial frequency of the at least one region into low frequency for each of sub-regions included in the at least one region.

4. The projection apparatus according to claim 3, wherein the correcting unit shifts each of the plurality of sub-regions of the projected image with respect to the printed image by each pixel, and converts a spatial frequency of the at least one region of the image data into low frequency, the at least one region corresponding to each of sub-regions where the misalignment still remains after the shifting.

5. The projection apparatus according to claim 3, wherein the correcting unit makes a degree of conversion into low frequency small for the sub-regions including a number of low-frequency components and makes a degree of conversion into low frequency large for the sub-regions including a number of high-frequency components.

6. The projection apparatus according to claim 1, further comprising a notification unit configured to provide notification about whether or not the correcting unite, converts the spatial frequency of the at least one region of the image data into low frequency.

7. The projection apparatus according to claim 3, wherein the correcting unit repeatedly carries out the conversion process each time a predetermined period has elapsed.

8. Control method for a projection apparatus which projects an image on printed material, the control method comprising:
a detecting step of detecting a misalignment between a projected image, which is formed by projecting an image on the printed material based on image data, and a printed image formed on the printed material; and
a control step of controlling to project an image on the printed material based on a converted image data obtained by converting a spatial frequency of at least one region of the image data into low frequency, the at least one region of the image data including the misalignment detected in the detecting step.

9. A non-transitory computer-readable storage medium storing a program for causing a computer to execute a control method for a projection apparatus which projects an image on printed material, the control method comprising:
a detecting step of detecting a misalignment between a projected image, which is formed by projecting an image on the printed material based on image data, and a printed image formed on the printed material; and
a control step of control to project an image on the printed material based on a converted image data obtained by converting a spatial frequency of at least one region of the image data into low frequency, the at least one region of the image data including the misalignment detected in the detecting step.

10. A projection apparatus which projects a projected image on printed image on a screen, the projection apparatus comprising:
an obtaining unit configured to obtain image data corresponding to the printed image;
a projection unit configured to project the projected image on the printed image;
a input unit configured to input an instruction by a user, and
a control unit configured to control the projection unit to project the projected image on the printed image based on the instruction by the user,
wherein:
in a case that a predetermined instruction is inputted, the control unit controls the projection unit to project the projected image based on a converted image data, the converted image data obtained by converting a spatial frequency of at least one region of the image data into low frequency, and
in a case that the predetermined instruction is not inputted, the control unit controls the projection unit to project the projected image based on the image data without the conversion.
